(19) United States
(12) Patent Application Publication
(10) Pub. No.: US 2025/0251284 A1
(43) Pub. Date: Aug. 7, 2025

(54) INTERFERENCE COLOR EVALUATION METHOD, OPTICAL FILM, POLARIZING PLATE, AND IMAGE DISPLAY DEVICE

(71) Applicant: DAI NIPPON PRINTING CO., LTD., Tokyo (JP)

(72) Inventors: Minoru KATO, Okayama-shi, Okayama (JP); Gen FURUI, Okayama-shi, Okayama (JP)

(21) Appl. No.: 18/549,080

(22) PCT Filed: Mar. 7, 2022
(86) PCT No.: PCT/JP2022/009722

§ 371 Date: Dec. 13, 2023

(30) Foreign Application Priority Data
Mar. 8, 2021 (JP) 2021-036530

(51) Int. Cl. G01J 3/50; G01J 3/02; G01J 3/46

(52) U.S. Cl. CPC G01J 3/501; G01J 3/0224; G01J 2003/467

(57) ABSTRACT

A method for evaluating an interference color having Step 1 to Step 3 described below, and evaluating an interference color by one kind of variance or a combination of two or more kinds of variance that are calculated by Step 4 described below.
Step 1: Display a surface light source including a polarizer in white, and emit linearly polarized white light L1 from the surface light source.
Step 2: Measure in-plane distribution of tristimulus values with respect to L1. Define the tristimulus values of L1 measured in the present step as tristimulus values 1.
Step 3: Display the surface light source in white in a state where an optical film is installed on the surface light source. Subsequently, measure in-plane distribution of tristimulus values with respect to light L2 that is LI transmitted through the optical film. Define the tristimulus values of L2 measured in the present step as tristimulus values 2.
Step 4: Divide an inside of a plane where tristimulus values 1 and tristimulus values 2 are measured into a plurality of sections. Calculate a color parameter for each of the sections from tristimulus values 1 and tristimulus values 2. Subsequently, calculate the variance of color parameters of all the sections. Carry out calculation of the variance for one kind or two or more kinds of color parameters.

### TECHNICAL FIELD

The present disclosure relates to a method for evaluating an interference color, an optical film, a polarization plate, and an image display device.

### BACKGROUND ART

An image display device such as a television, a notebook PC, or a monitor of a desktop PC may have an optical film on a display element. It is known that when the optical film has a phase difference, interference colors are observed depending on a viewing angle. Interference colors are significantly observed when they are viewed through polarized sunglasses, but are also observed when they are viewed with naked eyes.

In order to suppress interference colors due to phase differences in optical films, various optical films have been proposed. A method for evaluating an interference color when an optical film is applied to an image display device is exclusively a sensory evaluation by human visual inspection (PTL 1).

Further, PTL 2 and PTL 3 have been proposed as methods for evaluating display unevenness of image display devices.

### CITATION LIST

### Patent Literature

PTL 1: JP 2019-124919 A
PTL 2: JP 2010-151527 A
PTL 3: WO 2013/175973

### SUMMARY OF INVENTION

### Technical Problem

Since a conventional method for evaluating an interference color as PTL 1 is a sensory evaluation by human visual inspection, inclusion of human subjectivity has caused problems that variation occurs to evaluation, and evaluation accuracy deteriorates.

The methods of PTL 2 and PTL 3 are capable of objectively evaluating display unevenness of the image display devices. However, the methods of PTL 2 and PTL 3 are for evaluating the entire image display devices, and therefore are unable to evaluate to what extent optical films affect the display unevenness of the image display devices.

An object of the present disclosure is to provide a method capable of objectively evaluating interference colors due to influence of an optical film. Further, an object of the present disclosure is to provide an optical film, a polarization plate, and an image display device, in which interference colors are suppressed.

### Solution to Problem

The present disclosure provides a method for evaluating an interference color of [1] to as follows.
[1] A method for evaluating an interference color, comprising Step 1 to Step 3 described below, and evaluating the interference color by one kind of variance, or a combination of two or more kinds of variance, calculated according to Step 4 described below.
Step 1: Display a surface light source including a polarizer in white, and emit linearly polarized white light L1 from the surface light source.
Step 2: Measure in-plane distribution of tristimulus values with respect to L1. Define the tristimulus values of L1 measured in the present step as tristimulus values 1.
Step 3: Display the surface light source in white in a state where an optical film is installed on the surface light source. Subsequently, measure in-plane distribution of tristimulus values with respect to light L2 that is L1 transmitted through the optical film. Define the tristimulus values of L2 measured in the present step as tristimulus values 2.
Step 4: Divide an inside of a plane where tristimulus values 1 and tristimulus values 2 are measured into a plurality of sections. Calculate a color parameter for each of the sections from tristimulus values 1 and tristimulus values 2. Subsequently, calculate the variance of color parameters of all the sections. Carry out calculation of the variance for one kind or two or more kinds of color parameters.
[2] The method for evaluating an interference color as set forth in [1], wherein, as the variance, any member or members selected from Group 1 described below is included.

### <Group 1>

Variance of a* value of a Lab color system, variance of b* value of the Lab color system, variance of {(a* value of the Lab color system)²+(b* value of the Lab color system)²}^{1/2}, variance of u* value of a Luv color system, variance of v* value of the Luv color system, variance of {(u* value of the Luv color system)²+(v* value of the Luv color system)²}^{1/2}
[3] The method for evaluating an interference color as set forth in [1], wherein, as the variance, one member selected from Group 2-1 described below, and one member selected from Group 2-2 described below are included (Note that the variance of Group 2-2 is variance different from the variance selected from Group 2-1.).

### <Group 2-1>

Variance of a* value of a Lab color system, variance of b* value of the Lab color system, variance of {(a* value of the Lab color system)²+(b* value of the Lab color system)²}^{1/2}

### <Group 2-2>

Variance of L* value of the Lab color system, variance of the a* value of the Lab color system, variance of the b* value of the Lab color system, variance of {(a* value of the Lab color system)²+(b* value of the Lab color system)²}^{1/2}
[4] The method for evaluating an interference color as set forth in [1], wherein, as the variance, one member selected from Group 3-1 described below, and one member selected from Group 3-2 described below are included (Note that the variance of Group 3-2 is different variance from the variance selected from Group 3-1.).

### <Group 3-1>

Variance of u* value of a Luv color system, variance of v* value of the Luv color system, variance of {(u* value of the Luv color system)²+ (v* value of the Luv color system)²}^{1/2}

### <Group 3-2>

Variance of L* value of the Luv color system, the variance of the u* value of the Luv color system, variance of the v* value of the Luv color system, variance of {(u* value of the Luv color system)²+ (v* value of the Luv color system)²}^{1/2}
[5] The method for evaluating an interference color as set forth in any one of [1] to [4], wherein measurement of the tristimulus values 1 of the Step 2 and measurement of the tristimulus values 2 of the Step 3 are respectively carried out at a plurality of measurement angles, and the Step 4 is carried out at each of the measurement angles.
[6] The method for evaluating an interference color as set forth in [1], wherein, as the variance, variance of a* value of a Lab color system and variance of b* value of the Lab color system are included, and the interference color is evaluated by a sum of the variance of the a* value of the Lab color system and the variance of the b* value of the Lab color system.
[7] The method for evaluating an interference color as set forth in [6], wherein when the sum is 5.00 or less, the interference color is evaluated as being suppressed.
[8] The method for evaluating an interference color as set forth in [1], wherein, as the variance, variance of a* value of a Lab color system and variance of b* value of the Lab color system are included, and an interference color is evaluated by a product of the variance of the a* value of the Lab color system and the variance of the b* value of the Lab color system.
[9] The method for evaluating an interference color as set forth in [8], wherein when the product is 4.000 or less, the interference color is evaluated as being suppressed.
[10] The method for evaluating an interference color as set forth in [1], wherein, as the variance, a square root of variance of a* value of a Lab color system and a square root of variance of b* value of the Lab color system are included, and the interference color is evaluated by a sum of the square root of the variance of the a* value of the Lab color system and the square root of the variance of the b* value of the Lab color system.
[11] The method for evaluating an interference color as set forth in [10], wherein when the sum is 3.00 or less, the interference color is evaluated as being suppressed.
[12] An optical film,
wherein variance of two or more kinds of color parameters of the optical film calculated by Step 1 to Step 4 described below satisfies one or more members selected from the group of (1) to (3) described below.
Step 1: Display a surface light source including a polarizer in white, and emit linearly polarized white light L1 from the surface light source.
Step 2: Measure in-plane distribution of tristimulus values with respect to L1. A measurement angle is 60 degrees. Define the tristimulus values of L1 measured in the present step as tristimulus values 1.
Step 3: Display the surface light source in white in a state where the optical film is installed on the surface light source. Subsequently, measure in-plane distribution of the tristimulus values with respect to light L2 that is L1 transmitted through the optical film. A measurement angle is 60 degrees. Define the tristimulus values of L2 measured in the present step as tristimulus values 2.
Step 4: Divide an inside of a plane where the tristimulus values 1 and the tristimulus values 2 are measured into a plurality of sections. Calculate a color parameter for each of the sections from the tristimulus values 1 and the tristimulus values 2. Subsequently, calculate variance of color parameters of all the sections. Carry out calculation of the variance for two or more kinds of color parameters.
(1) A sum of variance of a* value of a Lab color system and variance of b* value of the Lab color system is 5.00 or less.
(2) A product of the variance of the a* value of the Lab color system and the variance of the b* value of the Lab color system is 4.000 or less.
(3) A sum of a square root of the variance of the a* value of the Lab color system and a square root of the variance of the b*value of the Lab color system is 3.00 or less.
[13] A polarization plate comprising a polarizer, a first protective film disposed on one side of the polarizer, and a second protective film disposed on another side of the polarizer, wherein at least either one of the first protective film and the second protective film is the optical film as set forth in [12].
[14] An image display device comprising a polarizer and an optical film on a display element,
wherein variance of two or more kinds of color parameters of the image display device calculated by Step 1 to Step 4 described below satisfies one or more members selected from the group of (1) to (3) described below.
Step 1: Display a surface light source including the polarizer on the display element in white, and emit linearly polarized white light L1 from the surface light source.
Step 2: Measure in-plane distribution of tristimulus values with respect to L1. A measurement angle is 60 degrees. Define the tristimulus values of L1 measured in the present step as tristimulus values 1.
Step 3: Display the surface light source in white in a state where the optical film is installed on the surface light source. Subsequently, measure in-plane distribution of tristimulus values with respect to light L2 that is L1 transmitted through the optical film. A measurement angle is 60 degrees. Define the tristimulus values of L2 measured in the present step as tristimulus values 2.
Step 4: Divide an inside of a plane where the tristimulus values 1 and the tristimulus values 2 are measured into a plurality of sections. Calculate a color parameter for each of the sections from the tristimulus values 1 and the tristimulus values 2. Subsequently, calculate variance of color parameters of all the sections. Carry out calculation of the variance for one kind or two or more kinds of color parameters.
(1) A sum of variance of a* value of a Lab color system and variance of b* value of the Lab color system is 5.00 or less.
(2) A product of the variance of the a* value of the Lab color system and the variance of the b* value of the Lab color system is 4.000 or less.
(3) A sum of a square root of the variance of the a* value of the Lab color system and a square root of the variance of the b* value of the Lab color system is 3.00 or less.

### Advantageous Effects of Invention

The method for evaluating an interference color of the present disclosure is capable of objectively evaluating an interference color due to the influence of the optical film. Further, the optical film, the polarization plate, and the image display device of the present disclosure can suppress interference colors.

### BRIEF DESCRIPTION OF DRAWINGS

FIG. 1 is a flowchart illustrating one embodiment of a method for evaluating an interference color of a present disclosure.

FIG. 2 is a schematic view explaining one embodiment of a positional relationship between a surface light source and a measurement device when measuring an in-plane distribution of tristimulus values.

FIG. 3 is a schematic view explaining one embodiment of a positional relationship between the surface light source and an optical film.

FIG. 4 is a schematic view explaining one embodiment of an arrangement of a polarizer included in the surface light source, and the optical film.

### DESCRIPTION OF EMBODIMENT

Hereinafter, a method for evaluating an interference color, an optical film, a polarization plate, and an image display device of the present disclosure will be described.

### [Method for Evaluating Interference Color]

The method for evaluating an interference color of the present disclosure is a method having Step 1 to Step 3 described below, and evaluating an interference color by one kind of variance, or a combination of two or more kinds of variance calculated from Step 4 described below.

In the present specification, the atmosphere during measurement and evaluation is at a temperature of 23° C.±5° C. and a relative humidity of 40% or more and 65% or less, unless otherwise specified. In the present specification, objects to be measured are exposed to the aforementioned atmosphere for 30 minutes or more prior to start of various measurements and evaluations, unless otherwise specified. In the present specification, a “Lab color system” means a “CIE Lab color system”, and a “Luv color system” means a “CIE Luv color system”.
Step 1: Display a surface light source including a polarizer in white, and emit linearly polarized white light L1 from the aforementioned surface light source.
Step 2: Measure in-plane distribution of tristimulus values with respect to the aforementioned L1. Define the tristimulus values of the aforementioned L1 measured in the present step as tristimulus values 1.
Step 3: Display the aforementioned surface light source in white in a state where an optical film is installed on the aforementioned surface light source. Measure in-plane distribution of tristimulus values with respect to light L2 that is the aforementioned L1 transmitted through the aforementioned optical film. Define the tristimulus values of the aforementioned L2 measured in the present step as tristimulus values 2.
Step 4: Divide an inside of a plane where the aforementioned tristimulus values 1 and the aforementioned tristimulus values 2 are measured into a plurality of sections. Calculate a color parameter for each of the sections from the aforementioned tristimulus values 1 and the aforementioned tristimulus values 2. Calculate variance of color parameters in all the sections. Carry out calculation of the aforementioned variance for one kind, or two or more kinds of color parameters.

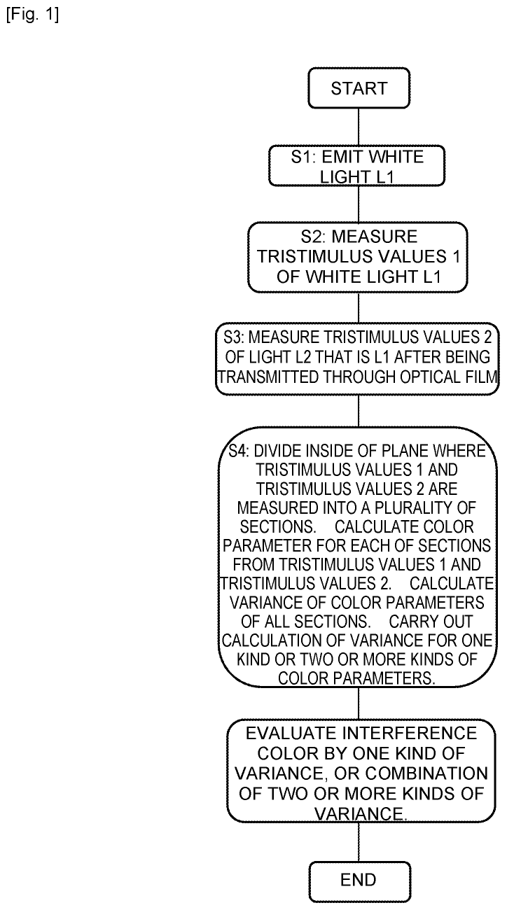

FIG. 1 is a flowchart illustrating one embodiment of the method for evaluating an interference color of the present disclosure. In the flowchart in FIG. 1, the “Step 1, Step 2, Step 3, Step 4” is denoted as “S1, S2, S3, S4”.

In Step 2 and Step 3, in-plane distributions of tristimulus values of the white light L1 and the transmitted light L2 can be measured by any measurement device.

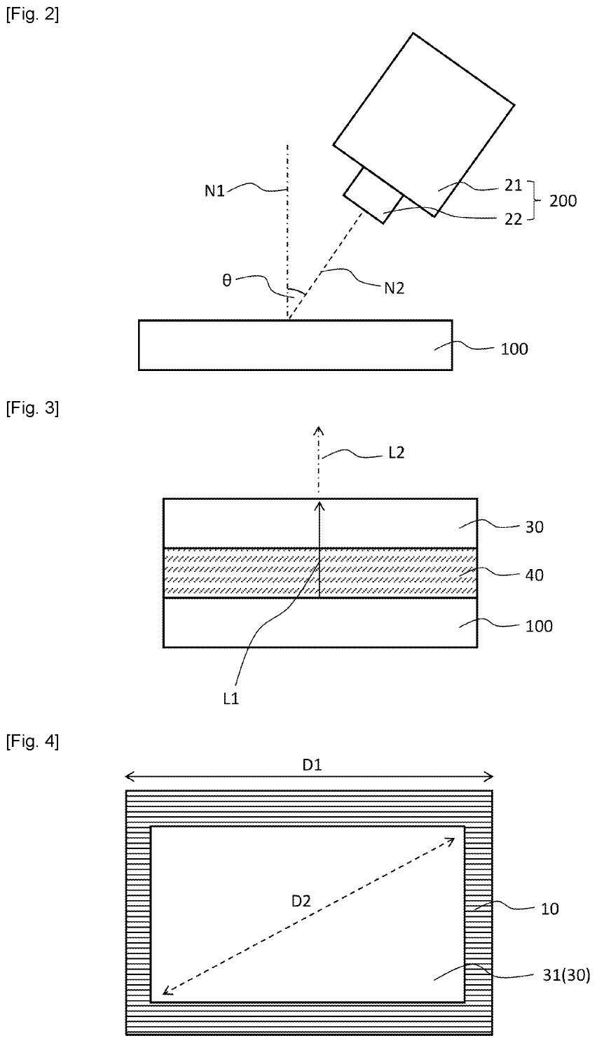

The measurement device is not particularly limited as long as the measurement device can measure the tristimulus values in the plane. A measurement device 200 has, for example, a device body 21, and a lens 22 fitted to the device body (FIG. 2). The device body preferably has a photodetector. As the photodetector, a CCD image sensor is cited. The number of pixels of the photodetector of the device body is preferably 1.2 million pixels or more, and more preferably 1.3 million pixels or more. An upper limit of the number of pixels of the photodetector is not particularly limited, but is preferably 2 million pixels or less. The measurement device preferably contains software for calculating a predetermined color parameter from the tristimulus values 1 and the tristimulus values 2 using the tristimulus values 1 as tristimulus values of white serving as a reference point.

By the above-described measurement device, tristimulus values of each of pixels of the white light L1 and the transmitted light L2 can be obtained in Step 2 and Step 3.

Reduced scales of members included in FIG. 2 are schematically depicted for convenience of illustration and are different from actual reduced scales. The same applies to FIG. 3 and FIG. 4.

As a device capable of measuring the in-plane distribution of the tristimulus values, for example, the tradename of TOPCON TECHNOHOUSE CORPORATION “2D Color Luminance meter UA-200” can be cited. By installing software (tradename “UA series application_ver4.1.0”) attached to the aforementioned measurement device, the aforementioned measurement device can calculate a predetermined color parameter from the tristimulus values 1 and the tristimulus values 2 with the tristimulus values 1 as the tristimulus values of white that is the reference point. When the aforementioned measurement device in which the aforementioned software is installed is used, a color parameter selected on the aforementioned software can be measured.

In the present specification, the tristimulus values mean an X value, a Y value, and a Z value of a CIE XYZ color system, and can be converted to an x value and a y value of a Yxy color system by using the equations described below. The Y value of the Yxy color system, and the Y value of the XYZ color system are a same parameter.

$$x = X / ( X + Y + Z )$$

$$y = Y / ( X + Y + Z )$$

$$z = Z / ( X + Y + Z )$$

$$x + y + z = 1$$

### <Step 1>

In Step 1, the surface light source including the polarizer is displayed in white, and the linearly polarized white light L1 is emitted from the aforementioned surface light source.

As the surface light source including a polarizer, a laminate having a polarizer on a light source capable of displaying white light can be cited. As the light source capable of displaying white light, lighting such as LED lighting and organic EL lighting, and display elements such as organic EL display elements are cited. As the surface light source including a polarizer, an image display device including a polarizer may be used.

The Y value, the x value, and the y value of the Yxy color system of the white light L1 are preferably in the following ranges. Further, the Y value, the x value, and the y value described below are values of the white light L1 emitted from a center in the plane of the surface light source, and a measurement angle is 60 degrees.

The Y value is preferably 40 or more and 400 or less, and more preferably 50 or more and 350 or less.

The x value is preferably 0.25 or more and 0.45 or less, and more preferably 0.30 or more and 0.40 or less.

The y value is preferably 0.25 or more and 0.45 or less, and more preferably 0.30 or more and 0.40 or less.

The polarizer has a function of converting white light into the linearly polarized white light L1. The polarizer is preferably positioned on a light exit surface side of a light source capable of displaying white light such as lighting, and display elements.

As the polarizer, there are cited, for example, a sheet type polarizer obtained by stretching a film dyed with iodine or the like (a polyvinyl alcohol film, polyvinyl formal film, polyvinyl acetal film, ethylene-vinyl acetate copolymer-based saponified film, and the like), a wire grid polarizer comprising a large number of metal wires arranged in parallel, a coated polarizer coated with a lyotropic liquid crystal and a dichroic guest-host material, a multilayer thin-film polarizer, and the like. These polarizers may be reflective polarizers including a function of reflecting non-transmissive polarization components.

The polarizer preferably has a degree of polarization of 95.00% or more, more preferably 98.0% or more, and even more preferably 99.0% or more.

The polarizer preferably has a total light transmittance of 35% or more, more preferably 37% or more, and even more preferably 40% or more. The total light transmittance of the polarizer is preferably 65% or less, more preferably 55% or less, and even more preferably 45% or less. In the present specification, the total light transmittance refers to the total light transmittance specified in JIS K7361-1:1997.

Surfaces on both sides of the polarizer preferably have a protective layer.

As the protection layer, glass, a plastic film and the like are cited. The protective layer preferably has optical isotropy. In the present specification, optical isotropy refers to an in-plane phase difference of less than 20 nm, preferably 10 nm or less, and even more preferably 5 nm or less.

The polarizer and the protective layer may be directly in close contact with each other or in close contact with each other via an adhesive layer.

### <Step 2>

In Step 2, the in-plane distribution of the tristimulus values is measured with respect to the aforementioned L1. The tristimulus values of the aforementioned L1 measured in the present step are defined as the tristimulus values 1.

The tristimulus values 1 measured in Step 2 are tristimulus values of white serving as a reference point for calculating a color parameter.

By Step 2, the aforementioned tristimulus values 1 of a predetermined number of pixels are obtained. The “predetermined number of pixels” obtained in Step 2 is based on the number of pixels of the photodetector of the device body.

Step 2 and Step 3 described later are carried out in a dark room environment.

The in-plane distribution of the tristimulus values of L1 can be measured by, for example, the aforementioned measurement device. A focus of the measurement device is preferably aligned with a surface of the surface light source.

Measurement conditions when measuring the in-plane distribution of the tristimulus values of L1 by the measurement device are not particularly limited, but the measurement angle, a distance, a measurement region and the like are preferably defined as conditions that will be described later.

An angle formed by the surface light source and the measurement device is preferably 15 degrees or more, and more preferably 30 degrees or more. An interference color is more likely to be observed as the angle becomes larger (more accurately, the interference color does not occur in Step 2, and the interference color occurs in Step 3). Further, the angle formed by the surface light source and the measurement device is preferably 75 degrees or less, and more preferably 60 degrees or less because the screen is rarely viewed from extremely large angles.

In the present specification, the angle formed by the surface light source and the measurement device means an angle θ formed by a normal N1 of the surface light source, and a normal N2 of the lens of the measurement device (FIG. 2).

In the present specification, the “angle formed by the surface light source and the measurement device” may be referred to as a “measurement angle”.

The angle formed by the surface light source and the measurement device is preferably a same angle in Step 2 and Step 3.

When measurement of the tristimulus values 1 in Step 2 and measurement of the tristimulus values 2 in Step 3 are each carried out at a plurality of measurement angles, it is preferable to match the plurality of measurement angles in Step 2 with the plurality of measurement angles in Step 3. For example, if Step 2 is carried out at four measurement angles of 30 degrees, 40 degrees, 50 degrees, and 60 degrees, it is preferable that Step 3 is also carried out at four measurement angles of 30 degrees, 40 degrees, 50 degrees, and 60 degrees.

A distance between the surface light source and the measurement device can be appropriately adjusted according to specifications of the measurement device. A preferable distance is 200 mm or more and 440 mm or less, and more preferably 220 mm or more and 350 mm or less. In the present specification, the distance between the surface light source and the measurement device means a distance to the lens of the measurement device from the surface of the surface light source.

A size of a region for measuring the in-plane distribution of the tristimulus values of L1 is preferably 100 mm long×75 mm wide or more and 290 mm long×210 mm wide or less, and more preferably 180 mm long×130 mm wide or more and more preferably 200 mm long×150 mm wide or less.

### <Step 3>

The aforementioned surface light source is displayed in white in a state where the optical film is installed on the aforementioned surface light source. The in-plane distribution of the tristimulus values is measured with respect to the light L2 that is the aforementioned L1 transmitted through the aforementioned optical film. The tristimulus values of the aforementioned L2 measured in the present step are defined as the tristimulus values 2.

The tristimulus values 2 measured in Step 3 are the tristimulus values of the light L2 that is the white light serving as the reference after being transmitted through the optical film. By Step 3, it is possible to obtain the tristimulus values for each pixel of the transmission light L2.

By Step 3, the aforementioned tristimulus values 2 of a predetermined number of pixels are obtained. The “predetermined number of pixels” obtained in Step 3 is based on the number of pixels of the photodetector of the device body.

Between Step 2 and Step 3, the surface light source may be turned off once, or may remain displayed in white.

FIG. 3 is a schematic view explaining one embodiment of a positional relationship between a surface light source 100 and an optical film 30. In FIG. 3, an arrow of a solid line indicates the linearly polarized white light L1 emitted from the surface light source 100, and an arrow of a dashed line indicates the light L2 which is L1 transmitted through the optical film 30.

The surface light source 100 and the optical film 30 may simply be laminated, but are preferably laminated via an adhesive layer 40 as illustrated in FIG. 3. By laminating the surface light source 100 and the optical film 30 via the adhesive layer 40, the optical film 30 follows the surface of the surface light source 100, so that an influence by the optical film 30 of the interference color can be easily evaluated more accurately.

The in-plane distribution of the tristimulus values of L2 can be measured by the aforementioned measurement device, for example. The focus of the measurement device is preferably aligned with the surface of the optical film.

The measurement conditions when measuring the in-plane distribution of the tristimulus values of L2 by the measurement device are not particularly limited, but it is preferable that conditions such as the angle formed by the surface light source and the measurement device, the distance between the surface light source and the measurement device, and the size of the measurement region of the tristimulus values are the same conditions as in Step S2.

A region where the in-plane distribution of the tristimulus values of L1 is measured, and a region where the in-plane distribution of the tristimulus values of L2 is measured are preferably aligned with each other in the planar direction.

As the optical film, an optical film used in the image display device is cited.

As the optical film used in the image display device, there is cited a single plastic film, a functional film having a functional layer on the plastic film. As the functional layer, one or two or more selected from a group consisting of a hard coat layer, an antiglare layer, a low refractive index layer, a high refractive index layer, an antistatic layer, a transparent conductive layer and the like, are cited.

The number of optical films installed on the surface light source may be one, or two or more. When two or more optical films are used, the optical films are preferably laminated via an adhesive layer.

The optical film preferably comprises a stretched plastic film. A stretched plastic film tends to generate an interference color because the stretched plastic film has optical anisotropy and can easily exhibit the effect of the present disclosure.

The optical film preferably has optical anisotropy. In the present specification, optical anisotropy refers to an in-plane phase difference of 20 nm or more, preferably 100 nm or more and more preferably 300 nm or more. The optical film preferably has an in-plane phase difference of 5000 nm or less, more preferably 3000 nm or less, and even more preferably 2500 nm or less.

When the in-plane phase difference is too small or too large, the interference color is difficult to observe. Therefore, by setting the in-plane phase difference of the optical film to the aforementioned range, the effect of the present disclosure can be easily exhibited.

Note that the functional layer is usually optically isotropic. Therefore, the in-plane phase difference of the plastic film included in the optical film is preferably in the aforementioned range.

In the present specification, the in-plane phase difference (Re) of the plastic film is expressed by formula (1) described below by a refractive index nx in a slow axis direction that is a direction in which the refractive index is the largest in the plane, a refractive index ny in a fast axis direction that is a direction orthogonal to the aforementioned slow axis direction, and a thickness T [nm] of the plastic film. In the present specification, the in-plane phase difference means a value in a wavelength of 550 nm.

$$Re = ( nx - ny ) \times T [ nm ] \qquad ( 1 )$$

The optical film is preferably installed on the surface light source so that an angle formed by a slow axis of the plastic film, and a transmission axis of the polarizer included in the surface light source is in a range of 45 degrees±15 degrees. The aforementioned formed angle is more preferably in a range of 45 degrees±10 degrees, even more preferably in a range of 45 degrees±5 degrees, even more preferably in a range of 45 degrees±3 degrees, eve more preferably in a range of 45±1 degree, and most preferably 45 degrees. In the present specification, a “range of 45 degrees±a degrees” means “45 degrees-a degrees or more and 45 degrees±a degrees or less”.

When the angle formed by the slow axis of the plastic film and the transmission axis of the polarizer is in a vicinity of 0 degrees or in a vicinity of 90 degrees, an interference color is difficult to observe. Therefore, by setting the aforementioned formed angle in the aforementioned range, the effect of the present disclosure can easily be exhibited.

In FIG. 4, D1 indicates the direction of the transmission axis of the polarizer included in the surface light source, and D2 indicates a direction of the slow axis of the plastic film. In FIG. 4, an angle formed by D1 and D2 is 45 degrees.

An adhesive layer that causes the surface light source and the optical film to be in close contact with each other can be formed from a general-purpose adhesive. The adhesive layer preferably has optical transparency and is optically isotropic.

### <Step 4>

The method for evaluating an interference color of the present disclosure has Step 1 to Step 3 mentioned above, and has Step 4.

Hereinafter, Step 4 will be described by being divided into 4-1 to 4-3 described below.
4-1: Divide the inside of the plane where the aforementioned tristimulus values 1 and the aforementioned tristimulus values 2 are measured into a plurality of sections.
4-2: Calculate a color parameter for each of the sections from the aforementioned tristimulus values 1 and the aforementioned tristimulus values 2.
4-3: Calculate variance of color parameters of all the sections. Carry out the calculation of the aforementioned variance with respect to one kind or two or more kinds of color parameters.

In 4-1, the inside of the plane where the aforementioned tristimulus values 1 and the aforementioned tristimulus values 2 are measured is divided into a plurality of sections. At the time of division, the number of pixels of each of the sections is preferably made the same.

The number of sections is not particularly limited, but for reliability of a value of variance to be calculated, 10 lengthwise×10 broadwise or more is preferable, and 15 lengthwise×15 broadwise is more preferable. On the other hand, depending on the size of the measurement region, if the number of sections is excessively increased, the sections may exceed a resolution limit of the human eye. Therefore, the number of sections is preferably 30 lengthwise×30 broadwise or less, and more preferably 20 lengthwise×20 broadwise or less.

The number of divisions in the plane where the tristimulus values 1 are measured, and the number of divisions in the plane where the tristimulus values 2 are measured are preferably the same.

When one section is replaced with an area of the surface light source, the area of the one section is preferably 47 mm² or more and 237 mm² or less, and more preferably 92 mm² or more and 118 mm² or less.

In 4-2, the color parameter is calculated for each of the sections from the aforementioned tristimulus values 1 and the aforementioned tristimulus values 2. Since a single pixel is extremely small, it is difficult for the human eye to recognize a single pixel. On the other hand, by calculating the color parameter for each of the sections as in 4-2, variance calculated in 4-3 can be easily made an index that is easily recognized by the human eye.

The color parameter can be calculated from the aforementioned tristimulus values 1 that is the reference point of white and the aforementioned tristimulus values 2, by a general formula.

The color parameter for each of the sections can be calculated, for example, by (1) or (2) described below. In (1) described below, the sections can be divided after the color parameters are calculated.
(1) Calculate the color parameter for each pixel from the aforementioned tristimulus values 1 and the aforementioned tristimulus values 2. Calculate an average value of the color parameters of all pixels in the section for each of the sections, and define the aforementioned average value as the color parameter of each of the sections.
(2) For each of the sections, calculate an average value of the aforementioned tristimulus values 1 and an average value of the aforementioned tristimulus values 2. Calculate the color parameter for each of the sections from the average value of the aforementioned tristimulus values 1 and the average value of the aforementioned tristimulus values 2.

In the case of using the above-mentioned measurement device in which the above-mentioned software is installed, the color parameter for each pixel in the above-described (1) can be automatically measured. Thereafter, the inside of the plane is divided into desired sections, and the average value of the color parameters of all the pixels in the section is calculated, whereby the color parameter of each of the sections can be obtained.

The color parameter is a color parameter that can be calculated based on the tristimulus values, and, for example, an a* value of a Lab color system, a b* value of the Lab color system, {(a* value of the Lab color system)²+(b* value of the Lab color system)²}^{1/2}, a u* value of a Luv color system, a v* value of the Luv color system, {(u* value of the Luv color system)²+(v* value of the Luv color system)²}^{1/2}, and the like are cited. Further, on the precondition that the color parameters are combined with other parameters, an L* value of the Lab color system, and an L* value of the Luv color system are also cited as the color parameters.

In 4-3, the variance of the color parameters of all the sections is calculated. Calculation of the aforementioned variance is carried out with respect to one kind or two or more kinds of color parameters.

In the present specification, the “variance” means variance in statistics. The variance in statistics means an average of squares of the differences between the average value and individual data in a certain group of numerical data. The variance can be expressed by the equation described below, wherein “V” indicates variance, “n” indicates the number of data, “xᵢ” indicates a value of data, and “xₐᵥₑ” indicates an average value of data.

$$V = \frac{1}{n} {\sum }_{i = 1}^{n} {( {x}_{i} - {x}_{ave} )}^{2}$$

In Step 4 described above, after the tristimulus values 1 of the reference white light obtained in Step 2 are defined as the reference, the variance is calculated by comparing the aforementioned reference and the tristimulus values 2 of the light that is the reference white light obtained in Step 3, after being transmitted through the optical film. Accordingly, the variance calculated from Step 4 described above is an element with which the interference color due to the influence of the optical film can be evaluated objectively. The methods of PTL 2 and PTL 3 differ from the method for evaluating an interference color of the present disclosure in that there is no comparison with a reference.

The method for evaluating an interference color of the present disclosure preferably carries out measurement of the tristimulus values 1 of Step 2 described above and measurement of the tristimulus values 2 of Step 3 described above respectively at a plurality of measurement angles, and Step 4 described above is preferably carried out for each of the measurement angles.

Since an intensity of the interference color differs according to the angles, by having the steps mentioned above, the interference color can be evaluated for each of the angles, and variations of evaluation are increased, and accuracy of the evaluation can be enhanced more.

The measurement angle means the angle formed by the surface light source and the measurement device. The plurality of measurement angles are preferably selected from 15 degrees or more and 75 degrees or less, and more preferably selected from 30 degrees or more and 60 degrees or less.

### <Evaluation>

The method for evaluating an interference color of the present disclosure evaluates an interference color by one kind of variance or a combination of two or more kinds of variance that are calculated from Step 4 described above.

When the interference color is evaluated with one kind of variance, it is possible to objectively evaluate the larger the value of the variance, the stronger the interference color, and the smaller the value of the variance, the weaker the interference color. An absolute value of the variance varies due to difference in surface light source, but the intensity of the interference color can be evaluated objectively by a magnitude of the value of the variance.

By setting a predetermined value as a threshold of pass/fail concerning one kind of variance, pass/fail of the interference color can be objectively evaluated. Since the absolute value of the variance varies due to the difference in surface light source, it is preferable to set a threshold for each surface light source.

As techniques for evaluating interference colors by a combination of two or more kinds of variance, “sum of one variance and another variance”, “sum of a square root of one variance and a square root of another variance”, “product of one variance and another variance” and the like are cited. Since a hue is usually embodied by two or more color parameters, it is possible to evaluate the intensity of the interference color more objectively by evaluating the interference color by the combination of two or more kinds of variance.

With the “sum of one variance and another variance”, the “sum of the square root of one variance and the square root of another variance” and the “product of one variance and another variance”, it is possible to objectively evaluate that the larger the values of the sum and the product, the stronger the interference color, and the smaller the values of the sums and the product, the weaker the interference color. Although the absolute values of the sum and the product vary due to the difference in surface light source, the intensity of the interference color can be objectively evaluated by the magnitudes of values of the sums and the product. In the present specification, the “square root of the variance” means a value of a positive square root for the variance. The value of the square root of the variance can be calculated by multiplying the right side of the formula of the variance described above by ½.

By setting the predetermined values of the sums and the product as thresholds of pass/fail, pass/fail of the interference color can be objectively evaluated. Since the absolute values of the sums and the product vary due to the difference in surface light source, it is preferable to set thresholds for each surface light source.

As the method for evaluating an interference color of the present disclosure, an embodiment is cited, which includes any member or members selected from Group 1 described below as the aforementioned variance.

### <Group 1>

Variance of the a* value of the Lab color system, variance of the b* value of the Lab color system, variance of {(a* value of the Lab color system)²+(b* value of the Lab color system)²}^{1/2}, variance of the u* value of the Luv color system, variance of the v* value of the Luv color system, variance of {(u* value of the Luv color system)²+(v* value of the Luv color system)²}^{1/2}

The variance of {(a* value of the Lab color system)²+(b* value of the Lab color system)²}^{1/2}, and the variance of {(u* value of the Luv color system)²+(v* value of the Luv color system)²}^{1/2} can be said to be variance of saturation. Since the saturation can embody the hue by itself, it is preferable to select the variance of {(a* value of the Lab color system)²+ (b* value of the Lab color system)²}^{1/2}, or the variance of {(u* value of the Luv color system)²+(v* value of the Luv color system)²}^{1/2} when only one member is selected from Group 1 described above.

As the method for evaluating the interference color of the present disclosure, an embodiment including one member selected from Group 2-1 described below, and one member selected from Group 2-2 described below as the aforementioned variance is cited (Note that the variance of Group 2-2 is different variance from the variance selected from Group 2-1.).

### <Group 2-1>

The variance of the a* value of the Lab color system, the variance of the b* value of the Lab color system, the variance of {(a* value of the Lab color system)²+(b* value of the Lab color system)²}^{1/2}

### <Group 2-2>

Variance of L* value of the Lab color system, the variance of the a* value of the Lab color system, the variance of the b* value of the Lab color system, the variance of {(a* value of the Lab color system)²+(b* value of the Lab color system)²}^{1/2}

A difference between Group 2-1 and Group 2-2 is that Group 2-2 includes the variance of the L* value of the Lab color system. Since the L* value is an index of brightness, it is difficult to evaluate the interference color only by the variance of the L* value of the Lab color system, but the interference color can be evaluated by combining the variance of the L* value with any variance of Group 2-1.

As the technique of combining one kind of variance selected from Group 2-1, and one kind of variance selected from Group 2-2, a sum and a product are cited, and the sum is preferable.

As the method for evaluating an interference color of the present disclosure, an embodiment including one member selected from Group 3-1 described below, and one member selected from Group 3-2 described below as the aforementioned variance is cited (Note that the variance of Group 3-2 is different variance from the variance selected from Group 3-1.).

### <Group 3-1>

The variance of the u* value of the Luv color system, the variance of the v* value of the Luv color system, the variance of {(u* value of the Luv color system)²+ (v* value of the Luv color system)²}^{1/2}

### <Group 3-2>

The variance of the L* value of the Luv color system, the variance of the u* value of the Luv color system, the variance of the v* value of the Luv color system, the variance of {(u* value of the Luv color system)²+ (v* value of the Luv color system)²}^{1/2}

A difference between Group 3-1 and Group 3-2 is that Group 3-2 includes the variance of the L* value of the Luv color system. Since the L* value is an index of brightness, it is difficult to evaluate the interference color only with the variance of the L* value of the Luv color system, but by combining the variance of the L* value with any variance of Group 3-1, the interference color can be evaluated.

As the technique of combining one member of variance selected from Group 3-1 and one member of variance selected from Group 3-2, a sum and a product are cited, and the sum is preferable.

As the method for evaluating an interference color of the present disclosure, an embodiment including any variance selected from Group 4 described below as the aforementioned variance.

### <Group 4>

A square root of the variance of the a* value of the Lab color system, a square root of the variance of the b* value of the Lab color system, a square root of the variance of {(a* value of the Lab color system)²+ (b* value of the Lab color system)²}^{1/2}, a square root of the variance of the u* value of the Luv color system, a square root of the variance of the v* value of the Luv color system, a square root of the variance of {(u* value of the Luv color system)²+(v* value of the Luv color system)²}^{1/2}

As the method for evaluating of an interference color of the present disclosure, an embodiment including one kind of variance selected from Group 5-1 described below and one kind of variance selected from Group 5-2 described below as the aforementioned variance is cited (Note that the variance of Group 5-2 is different variance from the variance selected from Group 5-1.)

### <Group 5-1>

The square root of the variance of the a* value of the Lab color system, the square root of the variance of the b* value of the Lab color system, the square root of the variance of {(a* value of the Lab color system)²+(b* value of the Lab color system)²}^{1/2}

### <Group 2-2>

A square root of the variance of the L* value of the Lab color system, the square root of the variance of the a* value of the Lab color system, the square root of the variance of the b* value of the Lab color system, the square root of the variance of {(a* value of the Lab color system)²+(b* value of the Lab color system)²}^{1/2}

A difference between Group 5-1 and Group 5-2 is that Group 5-2 includes the square root of the variance of the L* value of the Lab color system. Since the L* value is an index of brightness, it is difficult to evaluate the interference color with only the square root of the variance of the L* value of the Lab color system, but by combining the square root of the variance of the L* value with the square root of any variance of Group 5-1, the interference color can be evaluated.

As a technique of combining the square root of one kind of variance selected from Group 5-1 and the square root of one kind of variance selected from Group 5-2, a sum or a product is cited, and the sum is preferable.

As the method for evaluating an interference color of the present disclosure, an embodiment including one kind of variance selected from Group 6-1 described below, and one kind of variance selected from Group 6-2 described below as the aforementioned variance is cited (Note that the variance of Group 6-2 is different variance from the variance selected from Group 6-1.).

### <Group 6-1>

The square root of the variance of the u* value of the Luv color system, the square root of the variance of the v* value of the Luv color system, the square root of the variance of {(u* value of the Luv color system)²+ (v* value of the Luv color system)²}^{1/2}

### <Group 6-2>

A square root of the variance of the L* value of the Luv color system, the square root of the variance of the u* value of the Luv color system, the square root of the variance of the v* value of the Luv color system, the square root of the variance of {(u* value of the Luv color system)²+ (v* value of the Luv color system)²}^{1/2}

A difference between Group 6-1 and Group 6-2 is that Group 6-2 includes the square root of the variance of the L* value of the Luv color system. Since the L* value is the index of brightness, it is difficult to evaluate the interference color only with the square root of the variance of the L* value of the Luv color system, but by combining the square root of the variance of the L* value with any variance of Group 6-1, the interference color can be evaluated.

As the technique of combining one kind of variance selected from Group 6-1, and one kind of variance selected from Group 6-2, a sum and a product are cited, and the sum is preferable.

The method for evaluating an interference color of the present disclosure includes the variance of the a* value of the Lab color system and the variance of the b* value of the Lab color system as the aforementioned variance, and preferably evaluates the interference color by the sum of the variance of the a* value of the Lab color system and the variance of the b* value of the Lab color system.

It can be objectively evaluated that the larger the value of the sum of the variance of the a* value of the Lab color system and the variance of the b* value of the Lab color system, the stronger the interference color, and the smaller the value of the aforementioned sum, the weaker the interference color. An absolute value of the aforementioned sum varies due to the difference in surface light source, but the intensity of the interference color can be objectively evaluated by a magnitude of the value of the aforementioned sum.

By setting a predetermined value of the aforementioned sum as a threshold of pass/fail, pass/fail of the interference color can be objectively evaluated. The threshold of the aforementioned sum can be, for example, preferably 5.00 or less, more preferably 3.00 or less, even more preferably 2.00 or less, and even more preferably 1.30 or less. In other words, when the aforementioned sum is 5.00 or less, the interference color can be evaluated as being suppressed. However, since the absolute value of the aforementioned sum varies due to the difference in surface light source, it is preferable to set the threshold for each surface light source.

The value of the aforementioned sum also varies depending on the measurement angle. Therefore, it is preferable to set the threshold in consideration of the measurement angle. It is preferable to set the threshold of the aforementioned sum at 5.00 or less, under the precondition that the measurement angle is 60 degrees of less, for example.

The value of the aforementioned sum also varies due to the difference in surface light source. Therefore, it is preferable to set the threshold in consideration of characteristics of the white light L1. For example, it is preferable to set the threshold of the aforementioned sum at 5.00 or less under the precondition that the Y value, the x value, and the y value of the Yxy color system of the white light L1 are in a range described below. Further, the Y value, the x value, and the y value described below are values of the white light L1 emitted from the center in the plane of the surface light source, and the measurement angle is 60 degrees.

The Y value is preferably 40 or more and 400 or less, and more preferably 50 or more and 350 or less.

The x value is preferably 0.25 or more and 0.45 or less, and more preferably 0.30 or more and 0.40 or less.

The y value is preferably 0.25 or more and 0.45 or less, and more preferably 0.30 or more and 0.40 or less.

The method for evaluating an interference color of the present disclosure includes the variance of the a* value of the Lab color system and the variance of the b* value of the Lab color system as the aforementioned variance, and preferably evaluates the interference color by the product of the variance of the a* value of the Lab color system and the variance of the b* value of the Lab color system.

It is possible to objectively evaluate that the larger a value of the product of the variance of the a* value of the Lab color system and the variance of the b* value of the Lab color system, the stronger the interference color, and the smaller the value of the aforementioned product, the weaker the interference color. Although an absolute value of the aforementioned product varies due to the difference in surface light source, the intensity of the interference color can be objectively evaluated by a magnitude of the value of the aforementioned product.

By setting a predetermined value of the aforementioned product as the threshold of pass/fail, it is possible to objectively evaluate pass/fail of the interference color. The threshold of the aforementioned product can be, for example, preferably 4.000 or less, more preferably 1.000 or less, even more preferably 0.3000 or less, and even more preferably 0.058 or less. In other words, when the aforementioned product is 4.000 or less, the interference color can be evaluated as being suppressed. However, since an absolute value of the aforementioned product varies due to the difference in surface light source, it is preferable to set the threshold for each surface light source.

The value of the aforementioned product also varies depending on the measurement angle. Therefore, it is preferable to set the threshold in consideration of the measurement angle. For example, it is preferable to set the threshold of the aforementioned product to 4.000 or less on the precondition that the measurement angle is 60 degrees or less.

The value of the aforementioned product also varies depending on the difference in surface light source. Therefore, it is preferable to set the threshold in consideration of the characteristics of the white light L1. For example, it is preferable to set the threshold of the aforementioned product to 4.000 or less on the precondition that the Y value, the x value, and the y value of the Yxy color system of the white light L1 are in the ranges described below. Further, the Y value, the x value, and the y value described below are values of the white light L1 emitted from the center of the inside of the plane of the surface light source, and the measurement angle is 60 degrees.

The Y value is preferably 40 or more and 400 or less, and more preferably 50 or more and 350 or less.

The x value is preferably 0.25 or more and 0.45 or less, and more preferably 0.30 or more and 0.40 or less.

The y value is preferably 0.25 or more and 0.45 or less, and more preferably 0.30 or more and 0.40 or less.

The method for evaluating an interference color of the present disclosure preferably comprises, as the aforementioned variance, the square root of the variance of the a* value of the Lab color system and the square root of the variance of the b* value of the Lab color system, and evaluates the interference color by the sum of the square root of the variance of the a* value of the Lab color system and the square root of the variance of the b* value of the Lab color system.

It can be objectively evaluated that the larger the value of the sum of the square root of the variance of the a* value of the Lab color system and the square root of the variance of the b* value of the Lab color system, the stronger the interference color, and the smaller the value of the aforementioned sum, the weaker the interference color. Although an absolute value of the aforementioned sum varies due to the difference in surface light source, the intensity of the interference color can be objectively evaluated based on the magnitude of the value of the aforementioned sum.

By setting a predetermined value of the aforementioned sum as the threshold of pass/fail, it is possible to objectively evaluate pass/fail of the interference color. The threshold value of the aforementioned sum can preferably be 3.00 or less, more preferably 1.50 or less, and even more preferably 1.00 or less, for example. In other words, when the aforementioned sum is 3.00 or less, the interference color can be evaluated as being suppressed. However, since the absolute value of the aforementioned sum varies due to the difference in surface light source, it is preferable to set the threshold for each surface light source.

The value of the aforementioned sum also varies depending on the measurement angle. Therefore, it is preferable to set the threshold in consideration of the measurement angle. For example, it is preferable to set the threshold of the aforementioned sum to 3.00 or less on the precondition that the measurement angle is 60 degrees or less.

The value of the aforementioned sum also varies due to the difference in surface light source. Therefore, it is preferable to set the threshold in consideration of the characteristics of the white light L1. For example, it is preferable to set the threshold of the aforementioned sum to 3.00 or less on the precondition that the Y value, the x value, and the y value of the Yxy color system of the white light L1 are in the ranges described below. Further, the Y value, the x value, and the y value described below are values of the white light L1 emitted from the center of the inside of the plane of the surface light source, and the measurement angle is 60 degrees.

The Y value is preferably 40 or more and 400 or less, and more preferably 50 or more and 350 or less.

The x value is preferably 0.25 or more and 0.45 or less, and more preferably 0.30 or more and 0.40 or less.

The y value is preferably 0.25 or more and 0.45 or less, and more preferably 0.30 or more and 0.40 or less.

### [Optical Film]

The optical film of the present disclosure is
an optical film,
wherein in the aforementioned optical film, variance of two or more color parameters calculated by Step 1 to Step 4 described below satisfies one or more members selected from the group (1) to (3) described below.
Step 1: Display a surface light source including a polarizer in white, and emit the linearly polarized white light L1 from the aforementioned surface light source.
Step 2: Measure an in-plane distribution of tristimulus values with respect to the aforementioned L1. The measurement angle is 60 degrees. Define the tristimulus values of the aforementioned L1 measured in the present step as the tristimulus values 1.
Step 3: Display the aforementioned surface light source in white in the state where the aforementioned optical film is installed on the aforementioned surface light source. Measure the in-plane distribution of tristimulus values with respect to the light L2 that is the aforementioned light L1 transmitted through the aforementioned optical film. The measurement angle is 60 degrees. Define the tristimulus values of the aforementioned L2 measured in the present step as the tristimulus values 2.
Step 4: Divide the inside of the plane where the aforementioned tristimulus values 1 and the aforementioned tristimulus values 2 are measured into a plurality of sections. Calculate a color parameter for each of the sections based on the aforementioned tristimulus values 1 and the aforementioned tristimulus values 2. Then, calculate variance of the color parameters of all the sections. Carry out the calculation of the aforementioned variance with respect to two or more kinds of color parameters.
(1) A sum of the variance of the a* value of the Lab color system and the variance of the b* value of the Lab color system is 5.00 or less.
(2) A product of the variance of the a* value of the Lab color system and the variance of the b* value of the Lab color system is 4.000 or less.
(3) A sum of the square root of the variance of the a* value of the Lab color system and the square root of the variance of the b* value of the Lab color system is 3.00 or less.

In the optical film of the present disclosure, variance of two or more kinds of color parameters calculated by Step 1 to Step 4 preferably satisfy two or more selected from the group of (1) to (3) described above, and more preferably satisfy three.

As the optical film, a single plastic film, and a functional film having a functional layer on a plastic film are cited. As the functional layer, one member or two or more members selected from a group of a hard coat layer, an antiglare layer, a low refractive index layer, a high refractive index layer, an antistatic layer, a transparent conductive layer and the like are cited.

An embodiment of Step 1 to Step 4 of the optical film of the present disclosure is the same as the embodiment of Step 1 to Step 4 of the method for evaluating an interference color of the present disclosure described above except that the measurement angle is specified as 60 degrees.

### [Polarization Plate]

The polarization plate of the present disclosure is a polarization plate having a polarizer, a first protective film disposed on one side of the aforementioned polarizer, and a second protective film disposed on the other side of the aforementioned polarizer, wherein at least either one of the aforementioned first protective film and the aforementioned second protective film is the optical film of the present disclosure described above.

As the polarizer, there are cited, for example, a sheet type polarizer obtained by stretching a film dyed with iodine or the like (a polyvinyl alcohol film, a polyvinyl formal film, polyvinyl acetal film, an ethylene-vinyl acetate copolymer-based saponified film and the like), a wire grid polarizer comprising a large number of metal wires arranged in parallel, a coated polarizer coated with a lyotropic liquid crystal and a dichroic guest-host material, a multilayer thin film polarizer and the like. These polarizers may be reflective polarizers including a function of reflecting non-transmissive polarizing components.

The polarizer preferably has a degree of polarization of 95.00% or more, more preferably 98.0% or more, and even more preferably 99.0% or more.

The polarizer preferably has a total light transmittance of 35% or more, more preferably 37% or more, and even more preferably 40% or more. The total light transmittance of the polarizer is preferably 65% or less, more preferably 55% or less, and even more preferably 45% or less.

Only one of the first protective film and the second protective film may be the optical film of the present disclosure, or both of the protective films may be the optical film of the present disclosure.

### [Image Display Device]

The image display device of the present disclosure is
an image display device having a polarizer and an optical film on a display element,
in the aforementioned image display device, variance of two or more kinds of color parameters calculated by Step 1 to Step 4 described below satisfy one or more members selected from the group of (1) to (3) described below.
Step 1: Display a surface light source having the aforementioned polarizer in white on the aforementioned display element, and emit the linearly polarized white light L1 from the aforementioned surface light source.
Step 2: Measure an in-plane distribution of tristimulus values with respect to the aforementioned L1. A measurement angle is 60 degrees. Define the tristimulus values of the aforementioned L1 measured in the present steps as the tristimulus values 1.
Step 3: Display the aforementioned surface light source in white in a state where the aforementioned optical film is installed on the aforementioned surface light source. Then, measure the in-plane distribution of the tristimulus values with respect to the light L2 that is the aforementioned L1 transmitted through the aforementioned optical film. The measurement angle is 60 degrees. Define the tristimulus values of the aforementioned L2 measured in the present step as the tristimulus values 2.
Step 4: Divide the inside of the plane where the aforementioned tristimulus values 1 and the aforementioned tristimulus values 2 are measured into a plurality of sections. Calculate a color parameter for each of the sections based on the aforementioned tristimulus values 1 and the aforementioned tristimulus values 2. Then, calculate the variance of the color parameters of all the sections. Carry out the calculation of the aforementioned variance with respect to one kind or two or more kinds of color parameters.
(1) The sum of the variance of the a* value of the Lab color system and the variance of the b* value of the Lab color system is 5.00 or less.
(2) The product of the variance of the a* value of the Lab color system and the variance of the b* value of the Lab color system is 4.000 or less.
(3) The sum of the square root of the variance of the a* value of the Lab color system and the square root of the variance of the b* value of the Lab color system is 3.00 or less.

In the image display device of the present disclosure, variance of two or more kinds of color parameters calculated by Step 1 to Step 4 preferably satisfy two or more members selected from the group of (1) to (3) described above, and more preferably satisfy three.

As the display element, there are cited liquid crystal display elements, EL display elements such as organic EL display elements and inorganic EL display elements, LED display elements such as mini LED display elements and micro LED display elements, plasma display elements and the like. When the display element is a liquid crystal element, the surface light source requires a backlight on a light incident surface side of the liquid crystal display element.

As the optical film, a single plastic film, and a functional film having a functional layer on a plastic film are cited. As the functional layer, one kind or two or more members selected from a group of a hard coat layer, an antiglare layer, a low refractive index layer, a high refractive index layer, an antistatic layer, a transparent conductive layer and the like are cited.

An embodiment of Step 1 to Step 4 of the image display device of the present disclosure is the same as the embodiment of Step 1 to Step 4 of the method for evaluating an interference color of the present disclosure described above except that the measurement angle is specified as 60 degrees.

### EXAMPLES

The present disclosure will now be described in more detail based on examples, but the present disclosure is not intended to be limited by these examples.

The atmosphere at the time of measurement and evaluation of the examples was set at a temperature of 23±5° C., and a relative humidity of 40% or more and 65% or less. Further, before start of the measurement and evaluation, objects to be measured were exposed to the aforementioned atmosphere for 30 minutes or more and 60 minutes or less.

### 1. Material

The material and the device described below were prepared or produced.

### 1-1. Surface Light Source Including Polarizer

Surface light source 1 including a polarizer: a commercial image display device (tradename by Apple Inc. “iPad (registered trademark) MGLW2J/A”). The Y value, x value, and y value of the Yxy color system of the white light L1 are values described below (values when the measurement angle is 60 degrees).
   Y value: 60
   x value: 0.31
   y value: 0.32
A surface light source 2 including a polarizer: a surface light source formed by laminating a commercial polarization plate (degree of polarization: 99.0%) on commercial LED lighting (tradename of MUTOH INDUSTRIES LTD. “Light Board Slim SLT-A4C”) via an adhesive layer (Transparent adhesive layer with a thickness of 25 μm, a tradename of PANAC Co., Ltd. “PANACLEAN PD-S1”). The Y value, the x value, and the y value of the Yxy color system of the white light L1 are values described below (values when the measurement angle is 60 degrees).
   Y value: 330
   x value: 0.34
   y value: 0.36

### 1-2. Optical Film

Optical film 1: Biaxially oriented polyester film having an in-plane phase difference of 500 nm
Optical film 2: Biaxially oriented polyester film having an in-plane phase difference of 800 nm
Optical film 3: Biaxially oriented polyester film having an in-plane phase difference of 1000 nm
Optical film 4: Biaxially oriented polyester film having an in-plane phase difference of 2300 nm

### 1-3. Measurement Device

As the measurement device, a tradename by TOPCON TECHNOHOUSE CORPORATION “2D Color Luminance Meter UA-200” was prepared. The number of pixels of the photodetector of the aforementioned measurement device is 1.3 million. As for the objective lens, a standard type (UA-200A standard: f=8 mm) attached to the aforementioned measurement device was used.

### 2. Evaluation of Interference Color

### Example 1

The aforementioned surface light source 1 was displayed in white, and the linearly polarized white light L1 was emitted from the surface light source 1.

Next, the in-plane distribution of the tristimulus values of the aforementioned L1 was measured by using the aforementioned measurement device, and the tristimulus values 1 were obtained. The measurement was carried out in a dark room environment. At the time of measurement, focus was aligned with the surface of the surface light source 1. The distance between the aforementioned surface light source and the aforementioned measurement device at the time of measurement was 255 mm. Further, the tristimulus values were measured at four angles of 30 degrees, 40 degrees, 50 degrees, and 60 degrees that are angles formed by the aforementioned surface light source and the aforementioned measurement device. Measurement is performed for a region of substantially 176 mm long×132 mm wide although it depends on the measurement angle. After the tristimulus values 1 were obtained, the surface light source was turned off once.

Subsequently, the optical film 1 was pasted on the aforementioned surface light source 1 via the adhesive layer (Transparent adhesive layer of a thickness of 25 μm. The tradename of PANAC CO., Ltd. “PANACLEAN PD-S1”). An angle formed by a slow axis of the optical film 1 (biaxially oriented polyester film) and a transmission axis of the polarizer included in the surface light source 1 was 45 degrees. The surface light source 1 was displayed in white, and the linearly polarized white light L1 was emitted from the surface light source 1. With respect to the light L2 that is the aforementioned L1 transmitted through the aforementioned optical film 1, the in-plane distribution of the tristimulus values was measured by using the aforementioned measurement device, and the tristimulus values 2 were obtained. The measurement was carried out in a dark room environment. At the time of the measurement, focus was aligned with the surface of the optical film 1. The distance between the aforementioned surface light source and the aforementioned measurement device at the time of measurement was 255 mm. Further, the tristimulus values were measured at four angles of 30 degrees, 40 degrees, 50 degrees, and 60 degrees that are formed by the aforementioned surface light source and the aforementioned measurement device. Measurement is performed for the region of substantially 176 mm long×132 mm wide though it depends on the measurement angle. A region where the in-plane distribution of the tristimulus value of L1 was measured, and a region where the in-plane distribution of the tristimulus values of L2 was measured were aligned with each other in the planar direction. Further, the interference color was evaluated by visual inspection according to the evaluation criteria described below at the four angles of 30 degrees, 40 degrees, 50 degrees and 60 degrees in the state of measuring the tristimulus values.

Ten test subjects (healthy people in their 20s to 40s) evaluated the interference colors with 4 points for invisible interference color, 3 points for slightly visible interference color, 2 points for visible interference color but not noticeable, and 1 point for visible interference color that bothers. An average point of evaluations of 10 people was calculated and ranked. The result is shown in Table 1.

Subsequently, the inside of the plane where the tristimulus values 1 and the tristimulus values 2 were measured was divided into sections of 16 lengthwise×16 broadwise. From the tristimulus values 1 and the tristimulus values 2, the color parameter of the Lab color system was calculated for each pixel. For each of the sections, an average value of the color parameters of all the pixels in the section was calculated, and the aforementioned average value was defined as the color parameter of each of the sections. An average value of the color parameters is calculated for each of the sections and the aforementioned average value is defined as the color parameter of each of the sections. Then, variance of the color parameters of all the sections was calculated. As the aforementioned color parameter, two kinds of color parameters of the a* value of the Lab color system and the b* value of the Lab color system were used. The sum of the variance of the a* value and the variance of the b* value is shown in Table 1. Further, the product of the variance of the a* value and the variance of the b* value is shown in Table 2, and the sum of the square root of the variance of the a* value and the square root of the variance of the b* value is shown in Table 3.

### <Evaluation Criteria of Evaluation of Interference Colors by Visual Inspection>

A: The average point is 3.5 or more
B: The average point is 3.0 or more and less than 3.5
C: The average point is 2.0 or more and less than 3.0
D: The average point is less than 2.0

### Examples 2 to 8

The methods for evaluating an interference color of examples 2 to 8 were carried out in a same manner as in example 1 except that as the surface light source having the polarizer and the optical film, those described in Tables 1 to 3 were used.

### Examples 9 and 10

The methods for evaluating an interference color of examples 9 and 10 were carried out in a same manner as in example 3 except that the angle formed by the slow axis of the optical film 3 and the transmission axis of the polarizer included in the surface light source 1 was changed to the angles in Table 4, and the measurement angle and the observation angle were fixed to 40 degrees. The sums of the variance of the a* value and the variance of the b* value are shown in Table 4.

TABLE 1

| | | | measurement angle or observation angle | | | | | | | |
|---|---|---|---|---|---|---|---|---|---|---|
| | surface | | 30 degrees | | 40 degrees | | 50 degrees | | 60 degrees | |
| | light | optical | sum of | visual | sum of | visual | sum of | visual | sum of | visual |
| | source | film | variance | inspection | variance | inspection | variance | inspection | variance | inspection |
| Example 1 | 1 | 1 | 0.47 | A | 0.37 | A | 0.41 | A | 0.26 | A |
| Example 2 | 1 | 2 | 0.37 | A | 0.64 | B | 0.85 | B | 0.74 | B |
| Example 3 | 1 | 3 | 0.67 | B | 1.17 | C | 1.87 | C | 1.95 | C |
| Example 4 | 1 | 4 | 6.17 | D | 8.58 | D | 6.83 | D | 5.09 | D |
| Example 5 | 2 | 1 | 0.16 | A | 0.39 | A | 0.48 | A | 0.38 | A |
| Example 6 | 2 | 2 | 0.30 | A | 1.04 | B | 0.56 | B | 0.55 | B |
| Example 7 | 2 | 3 | 0.54 | B | 1.89 | C | 1.69 | C | 1.72 | C |
| Example 8 | 2 | 4 | 3.70 | C | 5.46 | D | 5.77 | D | 5.42 | D |

TABLE 2

| | | | measurement angle or observation angle | | | | | | | |
|---|---|---|---|---|---|---|---|---|---|---|
| | surface | | 30 degrees | | 40 degrees | | 50 degrees | | 60 degrees | |
| | light | optical | product of | visual | product of | visual | product of | visual | product of | visual |
| | source | film | variance | inspection | variance | inspection | variance | inspection | variance | inspection |
| Example 1 | 1 | 1 | 0.053 | A | 0.034 | A | 0.036 | A | 0.011 | A |
| Example 2 | 1 | 2 | 0.023 | A | 0.086 | B | 0.179 | B | 0.133 | B |
| Example 3 | 1 | 3 | 0.112 | B | 0.342 | C | 0.785 | C | 0.556 | C |
| Example 4 | 1 | 4 | 8.832 | D | 15.800 | D | 9.380 | D | 4.981 | D |
| Example 5 | 2 | 1 | 0.007 | A | 0.032 | A | 0.056 | A | 0.031 | A |
| Example 6 | 2 | 2 | 0.022 | A | 0.263 | B | 0.078 | B | 0.060 | B |
| Example 7 | 2 | 3 | 0.067 | B | 0.703 | C | 0.426 | C | 0.377 | C |
| Example 8 | 2 | 4 | 3.361 | C | 6.843 | D | 7.270 | D | 7.234 | D |

TABLE 3

| | | | measurement angle or observation angle | | | | | | | |
|---|---|---|---|---|---|---|---|---|---|---|
| | | | 30 degrees | | 40 degrees | | 50 degrees | | 60 degrees | |
| | | | sum of | | sum of | | sum of | | sum of | |
| | surface | | square | | square | | square | | square | |
| | light | optical | roots of | visual | roots of | visual | roots of | visual | roots of | visual |
| | source | film | variance | inspection | variance | inspection | variance | inspection | variance | inspection |
| Example 1 | 1 | 1 | 0.96 | A | 0.86 | A | 0.89 | A | 0.69 | A |
| Example 2 | 1 | 2 | 0.82 | A | 1.11 | B | 1.30 | B | 1.21 | B |
| Example 3 | 1 | 3 | 1.16 | B | 1.53 | C | 1.91 | C | 1.86 | C |
| Example 4 | 1 | 4 | 3.48 | D | 4.07 | D | 3.60 | D | 3.09 | D |
| Example 5 | 2 | 1 | 0.57 | A | 0.86 | A | 0.98 | A | 0.86 | A |
| Example 6 | 2 | 2 | 0.77 | A | 1.44 | B | 1.06 | B | 1.02 | B |
| Example 7 | 2 | 3 | 1.03 | B | 1.89 | C | 1.73 | C | 1.72 | C |
| Example 8 | 2 | 4 | 2.71 | C | 3.27 | D | 3.34 | D | 3.29 | D |

TABLE 4

| | | | angle formed | measurement angle | |
|---|---|---|---|---|---|
| | | | by slow axis of | or observation angle | |
| | surface | | optical film and | 40 degrees | |
| | light | optical | transmission axis | sum of | visual |
| | source | film | of polarizer | variance | inspection |
| Example 9 | 1 | 3 | 32 | 0.88 | B |
| Example 3 | 1 | 3 | 45 | 1.17 | C |
| Example 10 | 1 | 3 | 58 | 0.79 | B |

From the results of Tables 1 to 4, it can be confirmed that the methods for evaluating an interference color of the examples can objectively evaluate the interference colors by the value of variance. Further, from the result of Table 4, it can be confirmed that as the angle formed by the slow axis of the optical film and the transmission axis of the polarizer becomes closer to 45 degrees, the interference color becomes stronger. Therefore, it can be deemed that as the angle formed by the slow axis of the optical film and the transmission axis of the polarizer becomes closer to 45 degrees, usefulness of the method for evaluating an interference color of the examples is enhanced.

Further, from the results of Tables 1 to 3, it can be found that the optical film of the present disclosure and the image display device of the present disclosure that satisfy one or more members selected from the group of (1) to (3) described below can suppress the interference colors. Similarly, the polarization plate of the present disclosure using the aforementioned optical film as the polarizer protective film can suppress the interference colors.
(1) The sum of the variance of the a* value of the Lab color system and the variance of the b* value of the Lab color system is 5.00 or less.
(2) The product of the variance of the a* value of the Lab color system and the variance of the b* value of the Lab color system is 4.000 or less.
(3) The sum of the square root of the variance of the a* value of the Lab color system and the square root of the variance of the b*value of the Lab color system is 3.00 or less.

### REFERENCE SIGNS LIST

10: polarizer
100: surface light source
21: device body
22: lens
200: measurement device
30: optical film
31: plastic film

1. A method for evaluating an interference color, comprising Step 1 to Step 3 described below, and evaluating the interference color by one kind of variance, or a combination of two or more kinds of variance, calculated according to Step 4 described below.
Step 1: Display a surface light source including a polarizer in white, and emit linearly polarized white light L1 from the surface light source.
Step 2: Measure in-plane distribution of tristimulus values with respect to L1. Define the tristimulus values of L1 measured in the present step as tristimulus values 1.
Step 3: Display the surface light source in white in a state where an optical film is installed on the surface light source. Subsequently, measure in-plane distribution of tristimulus values with respect to light L2 that is L1 transmitted through the optical film. Define the tristimulus values of L2 measured in the present step as tristimulus values 2.
Step 4: Divide an inside of a plane where tristimulus values 1 and tristimulus values 2 are measured into a plurality of sections. Calculate a color parameter for each of the sections from tristimulus values 1 and tristimulus values 2. Subsequently, calculate the variance of color parameters of all the sections. Carry out calculation of the variance for one kind or two or more kinds of color parameters.

2. The method for evaluating an interference color according to claim 1, wherein, as the variance, any member or members selected from Group 1 described below is included.
<Group 1>
Variance of a* value of a Lab color system, variance of b* value of the Lab color system, variance of {(a* value of the Lab color system)²+(b* value of the Lab color system)²}^{1/2}, variance of u* value of a Luv color system, variance of v* value of the Luv color system, variance of {(u* value of the Luv color system)²+(v* value of the Luv color system)²}^{1/2}.

3. The method for evaluating an interference color according to claim 1, wherein, as the variance, one member selected from Group 2-1 described below, and one member selected from Group 2-2 described below are included (Note that the variance of Group 2-2 is variance different from the variance selected from Group 2-1.).
<Group 2-1>
Variance of a* value of a Lab color system, variance of b* value of the Lab color system, variance of {(a* value of the Lab color system)²+(b* value of the Lab color system)²}^{1/2}
<Group 2-2>
Variance of L* value of the Lab color system, variance of the a* value of the Lab color system, variance of the b* value of the Lab color system, variance of {(a* value of the Lab color system)²+(b* value of the Lab color system)²}^{1/2}

4. The method for evaluating an interference color according to claim 1, wherein, as the variance, one member selected from Group 3-1 described below, and one member selected from Group 3-2 described below are included (Note that the variance of Group 3-2 is different variance from the variance selected from Group 3-1.).
<Group 3-1>
Variance of u* value of a Luv color system, variance of v* value of the Luv color system, variance of {(u* value of the Luv color system)²+(v* value of the Luv color system)²}^{1/2}
<Group 3-2>
Variance of L* value of the Luv color system, the variance of the u* value of the Luv color system, variance of the v* value of the Luv color system, variance of {(u* value of the Luv color system)²+(v* value of the Luv color system)²}^{1/2}

5. The method for evaluating an interference color according to claim 1, wherein measurement of the tristimulus values 1 of the Step 2 and measurement of the tristimulus values 2 of the Step 3 are respectively carried out at a plurality of measurement angles, and the Step 4 is carried out at each of the measurement angles.

6. The method for evaluating an interference color according to claim 1, wherein, as the variance, variance of a* value of a Lab color system and variance of b* value of the Lab color system are included, and the interference color is evaluated by a sum of the variance of the a* value of the Lab color system and the variance of the b* value of the Lab color system.

7. The method for evaluating an interference color according to claim 6, wherein when the sum is 5.00 or less, the interference color is evaluated as being suppressed.

8. The method for evaluating an interference color according to claim 1, wherein, as the variance, variance of a* value of a Lab color system and variance of b* value of the Lab color system are included, and an interference color is evaluated by a product of the variance of the a* value of the Lab color system and the variance of the b* value of the Lab color system.

9. The method for evaluating an interference color according to claim 8, wherein when the product is 4.000 or less, the interference color is evaluated as being suppressed.

10. The method for evaluating an interference color according to claim 1, wherein, as the variance, a square root of variance of a* value of a Lab color system and a square root of variance of b* value of the Lab color system are included, and the interference color is evaluated by a sum of the square root of the variance of the a* value of the Lab color system and the square root of the variance of the b* value of the Lab color system.

11. The method for evaluating an interference color according to claim 10, wherein when the sum is 3.00 or less, the interference color is evaluated as being suppressed.

12. An optical film,
wherein variance of two or more kinds of color parameters of the optical film calculated by Step 1 to Step 4 described below satisfies one or more members selected from the group of (1) to (3) described below.
Step 1: Display a surface light source including a polarizer in white, and emit linearly polarized white light L1 from the surface light source.
Step 2: Measure in-plane distribution of tristimulus values with respect to L1. A measurement angle is 60 degrees. Define the tristimulus values of L1 measured in the present step as tristimulus values 1.
Step 3: Display the surface light source in white in a state where the optical film is installed on the surface light source. Subsequently, measure in-plane distribution of the tristimulus values with respect to light L2 that is L1 transmitted through the optical film. A measurement angle is 60 degrees. Define the tristimulus values of L2 measured in the present step as tristimulus values 2.
Step 4: Divide an inside of a plane where the tristimulus values 1 and the tristimulus values 2 are measured into a plurality of sections. Calculate a color parameter for each of the sections from the tristimulus values 1 and the tristimulus values 2. Subsequently, calculate variance of color parameters of all the sections. Carry out calculation of the variance for two or more kinds of color parameters.
(1) A sum of variance of a* value of a Lab color system and variance of b* value of the Lab color system is 5.00 or less.
(2) A product of the variance of the a* value of the Lab color system and the variance of the b* value of the Lab color system is 4.000 or less.
(3) A sum of a square root of the variance of the a* value of the Lab color system and a square root of the variance of the b*value of the Lab color system is 3.00 or less.

13. A polarization plate comprising a polarizer, a first protective film disposed on one side of the polarizer, and a second protective film disposed on another side of the polarizer, wherein at least either one of the first protective film and the second protective film is the optical film according to claim 12.

14. An image display device comprising a polarizer and an optical film on a display element,
wherein variance of two or more kinds of color parameters of the image display device calculated by Step 1 to Step 4 described below satisfies one or more members selected from the group of (1) to (3) described below.
Step 1: Display a surface light source including the polarizer on the display element in white, and emit linearly polarized white light L1 from the surface light source.
Step 2: Measure in-plane distribution of tristimulus values with respect to L1. A measurement angle is 60 degrees. Define the tristimulus values of L1 measured in the present step as tristimulus values 1.
Step 3: Display the surface light source in white in a state where the optical film is installed on the surface light source. Subsequently, measure in-plane distribution of tristimulus values with respect to light L2 that is L1 transmitted through the optical film. A measurement angle is 60 degrees. Define the tristimulus values of L2 measured in the present step as tristimulus values 2.
Step 4: Divide an inside of a plane where the tristimulus values 1 and the tristimulus values 2 are measured into a plurality of sections. Calculate a color parameter for each of the sections from the tristimulus values 1 and the tristimulus values 2. Subsequently, calculate variance of color parameters of all the sections. Carry out calculation of the variance for one kind or two or more kinds of color parameters.
(1) A sum of variance of a* value of a Lab color system and variance of b* value of the Lab color system is 5.00 or less.
(2) A product of the variance of the a* value of the Lab color system and the variance of the b* value of the Lab color system is 4.000 or less.
(3) A sum of a square root of the variance of the a* value of the Lab color system and a square root of the variance of the b* value of the Lab color system is 3.00 or less.
